(19) United States
(12) Patent Application Publication
(10) Pub. No.: US 2017/0214210 A1
(43) Pub. Date: Jul. 27, 2017

(54) LASER RESONATOR WITH PARASITIC MODE SUPPRESSION

(71) Applicant: Synrad, Inc., Mukilteo, WA (US)

(72) Inventors: Linh K. Nguyen, Woodinville, WA (US); Raymond L. Silta, North Bend, WA (US); Jason W. Bethel, Seattle, WA (US)

(73) Assignee: Synrad, Inc., Mukilteo, WA (US)

(21) Appl. No.: 14/265,743

(22) Filed: Apr. 30, 2014

(51) Int. Cl. H01S 3/08; H01S 3/097; H01S 3/038; H01S 3/22

(52) U.S. Cl. CPC H01S 3/08018; H01S 3/08059; H01S 3/22; H01S 3/09702; H01S 3/08095; H01S 3/0385; H01S 3/16

(57) ABSTRACT

A resonator for a laser includes a first resonator wall and a second resonator wall with a lasing medium disposed in a gap therebetween. The resonator further includes a first mirror disposed at a first end of the first and second resonator walls and a second mirror disposed at a second end of the first and second resonator walls. The mirrors cooperate to form an intra-cavity laser beam that travels along a plurality of paths through the lasing medium. Furthermore, the first mirror and the second mirror form a laser resonator for a parasitic laser mode. A parasitic mode suppressor is located within the superfluous region.

### BACKGROUND

Multi-pass laser resonators, also called multi-fold or folded laser resonators, are commonly used in lasers to achieve a long effective gain path while maintaining a short physical length for the resonator cavity. Although the folding of the beam path can occur in one, two or three dimensions, linearly folded multi-pass resonators have the advantage of being relatively easy to construct. Within the linear multi-pass configuration, complete free space, complete waveguide or hybrid operation can define the axes transverse to the beam path. While the use of a waveguide in the folded axis can constrain laser oscillation to a single mode, it is sometimes desirable to use free space propagation instead, due to the ability to more easily achieve a Gaussian beam in free space.

A multi-pass laser resonator, also referred to as a multi-pass optical cavity, may be formed by folding a stable single pass resonator one or more times via one or more mirrors. For example, FIG. 1A shows a stable single pass resonator 101 formed by two mirrors 103 and 105. Located between the two mirrors 103 and 105 is a gain medium 106 that causes an emission of electromagnetic energy that then builds up within the resonator 101. Due to the high reflectivity of the mirrors 103 and 105, most of the energy is contained within the resonator 101 and, as a result, an intra-cavity laser beam 107 is generated. The mirror 103, also commonly referred to as an output coupler, allows for a small fraction of the energy to leave the resonator in the form of output laser beam 109. The output laser beam 109 may be employed for a number of different uses, e.g., laser cutting, welding, marking, or any other use.

The intra-cavity laser beam 107 established between the mirrors 103 and 105 of the resonator 101 may oscillate in what is known as the fundamental mode of the resonator 101. The fundamental mode of the resonator 101 may be characterized, in part, by a particular beam shape in the transverse direction, i.e., in a direction that is perpendicular to the direction of propagation of the intra-cavity laser beam 107. For example, the fundamental mode of the resonator 101 may be characterized by a beam whose beam shape follows a Gaussian intensity distribution. As used herein, the radius of a Gaussian laser beam is defined to be the distance (from the center location of peak intensity in the beam) at which the intensity of the beam is reduced by a factor 1/e². Furthermore, a waist w₁ of a Gaussian beam occurs at the longitudinal position on the beam having the smallest radius. For example, for the stable resonator shown in FIG. 1A having one flat mirror 103 and one concave mirror 105 separated by a distance L1, the waist w₁ of the intra-cavity Gaussian laser beam 107 occurs at the surface of the flat mirror 103. Furthermore in this configuration, the separation between the mirrors 103 and 107 define what is referred to as the path length of the inter-cavity laser beam 107. Thus, for the in-line resonator configuration shown in FIG. 1A, the physical length of the resonator is equivalent to the path length L1.

FIG. 1B shows another arrangement where the physical length of the resonator may be shorter than the path length of the inter-cavity laser beam 107. In FIG. 1B, a lengthening of the path length of the inter-cavity laser beam 107 may be achieved by including flat turning mirror 111 within the cavity. The effect of flat turning mirror 111 is to fold the path of the inter-cavity laser beam 107 without necessarily changing the nature of the stable resonator depicted in FIG. 1A. For example, in the folded configuration shown in FIG. 1B, the physical length of the resonator L2 is approximately half the path length L1 of the inter-cavity laser beam 107. As shown in FIG. 1B the laser beam 107 makes two passes through the gain medium 106 with the first pass represented by portion 107a of laser beam 107 and the second pass represented by portion 107b of laser beam 107. Because the inter-cavity laser beam takes two passes through the gain medium 106, the folded configuration may achieve a higher gain, and a correspondingly higher output power in the output laser beam 109.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Illustrative embodiments of the present disclosure are directed to a resonator for a laser. The resonator includes a first resonator wall and a second resonator wall that is separated from the first resonator wall in a transverse direction thereby defining a gap between the first and second resonator walls. A lasing medium is disposed in the gap, a first mirror is disposed at a first end of the first and second resonator walls, and a second mirror disposed at a second end of the first and second resonator walls. The mirrors cooperate to form an intra-cavity laser beam that travels along a plurality of paths through the lasing medium, the plurality of paths defining a boundary of a superfluous region within the multi-pass resonator. Furthermore, the intra-cavity laser beam does not pass through the superfluous region. The first mirror and the second mirror form a laser resonator for a parasitic laser mode, a portion of which is located within the superfluous region. A parasitic mode suppressor is located within the superfluous region.

Other aspects of the invention will be apparent from the following description and the appended claims.

### BRIEF DESCRIPTION OF DRAWINGS

FIGS. 1A-1B show examples of laser resonators.

FIGS. 2A-2C show examples of a laser employing a laser resonator with parasitic mode suppression in accordance with one or more embodiments.

FIGS. 3A-3B show examples of resonators in accordance with one or more embodiments of the invention.

FIG. 4A-4C show examples of a resonator in accordance with one or more embodiments of the invention.

FIGS. 5A-5E show parasitic mode suppressors in accordance with one or more embodiments of the invention.

FIGS. 6A-6G show parasitic mode suppressors in accordance with one or more embodiments of the invention.

FIGS. 7A-7C show parasitic mode suppressors in accordance with one or more embodiments of the invention.

FIGS. 8A-8B show parasitic mode suppressors in accordance with one or more embodiments of the invention.

FIG. 9 shows a Paschen Curve in accordance with one or more embodiments.

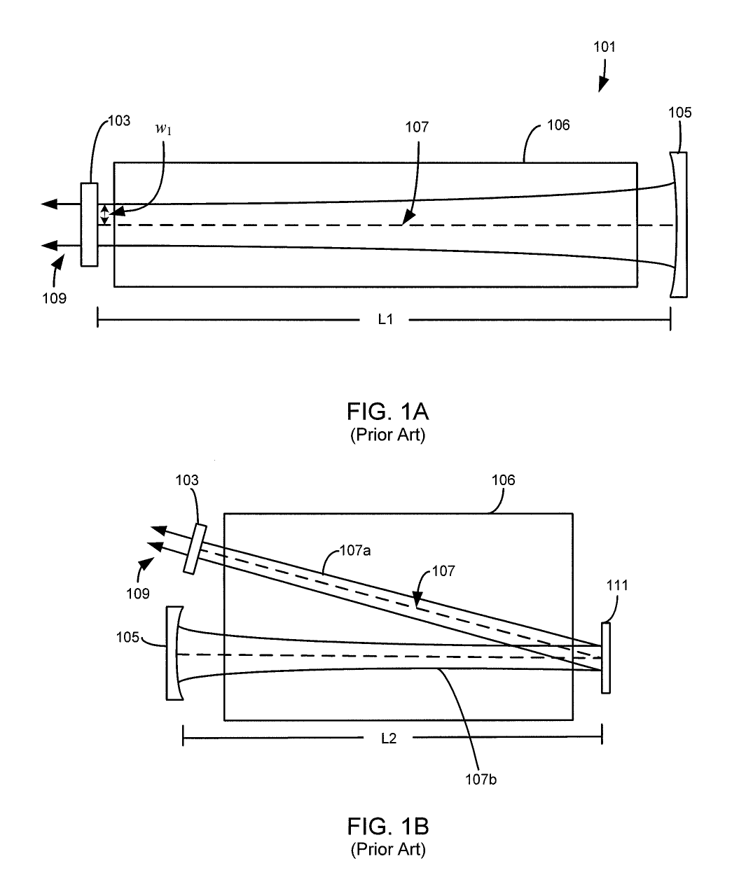

### DETAILED DESCRIPTION

Specific embodiments of a laser resonator with parasitic mode suppression will now be described in detail with reference to the accompanying figures. Like elements in the various figures (also referred to as FIGs.) are denoted by like reference numerals for consistency.

In the following detailed description of embodiments, numerous specific details are set forth in order to provide a more thorough understanding of the laser resonator with parasitic mode suppression. However, it will be apparent to one of ordinary skill in the art that these embodiments may be practiced without these specific details. In other instances, well-known features have not been described in detail to avoid unnecessarily complicating the description.

In general, the present disclosure is directed to a laser resonator with parasitic mode suppression. The resonator may include a pair of resonator walls in which at least one resonator wall possesses one or more recesses/protrusions located in regions of the gain medium not used by the desired laser oscillation. In accordance with one or more embodiments, the recesses/protrusions may be also located in regions used by parasitic oscillations. Such resonator walls may be the walls of a pair of electrodes or the walls of a chamber within an excited structure. For gas discharge laser embodiments, the depth of any recesses may be chosen so as to not only suppress a parasitic oscillation in the laser resonator but to also substantially reduce or eliminate a discharge in the area of the recess. Furthermore, a protrusion can be formed directly out of a resonator wall itself and also may be formed separately and then affixed to, or affixed within, the resonator. Furthermore, a protrusion can fully or partially span the gap between the resonator walls. For gas discharge lasers, the height of a protrusion can be chosen so as to suppress a discharge between the protruding surface and the other resonator wall surface while maintaining the protrusion's electrical isolation.

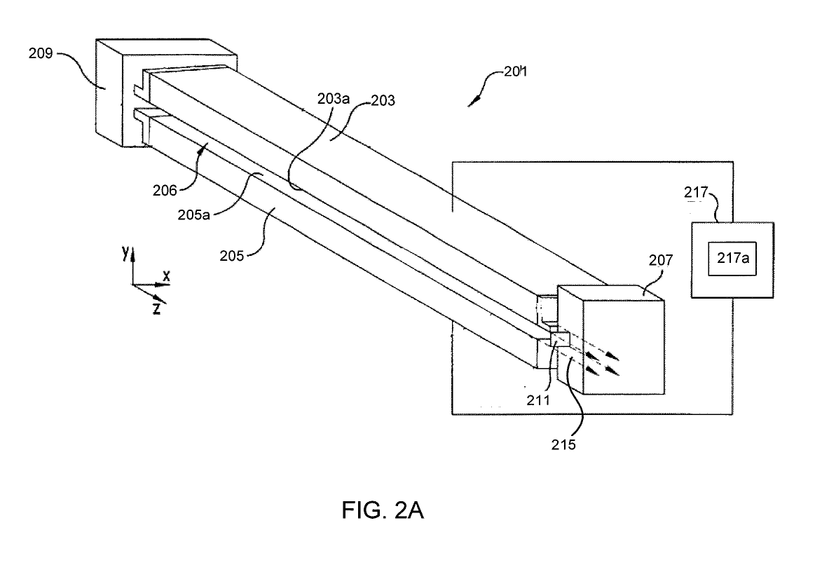

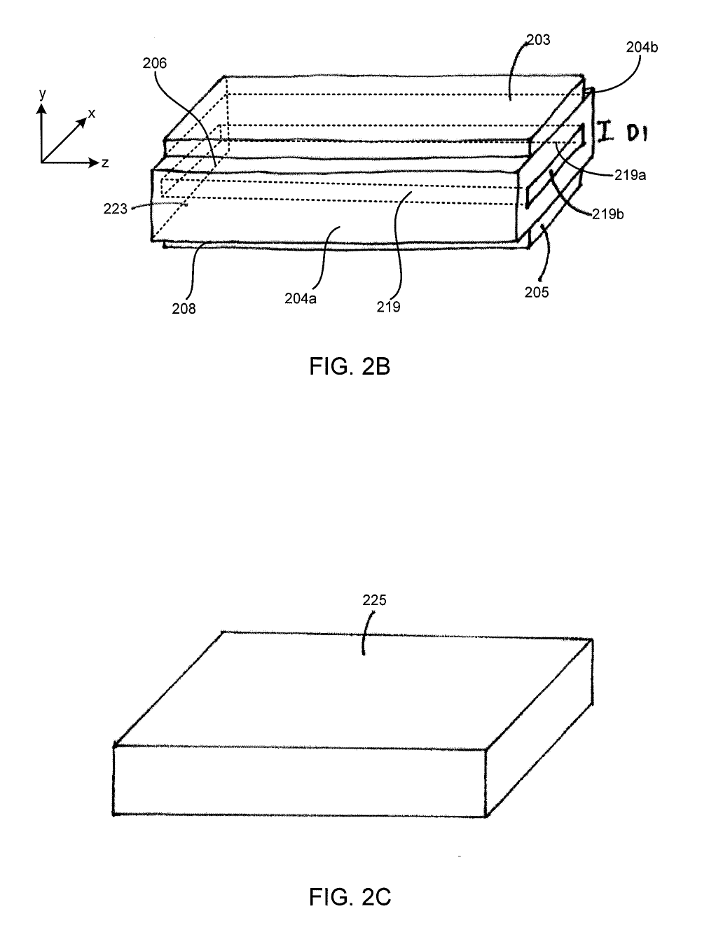

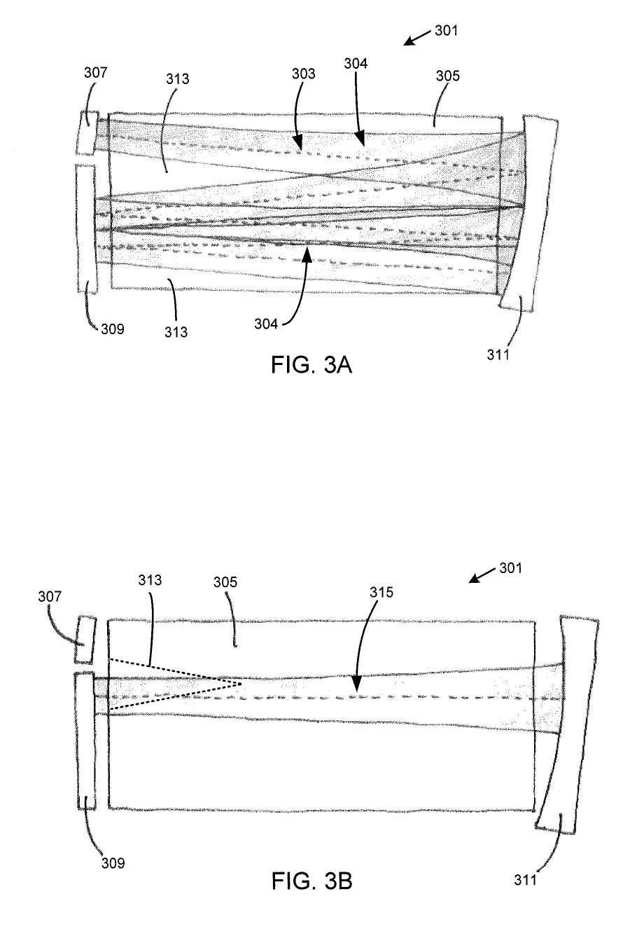

FIG. 2A shows an example of a laser employing a laser resonator, e.g., a multi-pass laser resonator, with parasitic mode suppression in accordance with one or more embodiments. Before the details of the parasitic mode suppression structures are discussed, the general components of the laser shown in FIG. 2A will be discussed. More specifically, FIG. 2A shows one example of a laser employing a laser resonator, e.g., multi-pass slab gas laser 201. However, other types of laser resonators may be employed without departing from the scope of the present disclosure. Furthermore, while the examples described herein may show resonator designs that employ a certain number of passes, e.g., 5 passes as shown below in FIG. 3A, a resonator employing any number of passes may be used without departing from the scope of the present disclosure. In accordance with one or more embodiments, the slab laser 201 includes a first elongated planar electrode 203 and a second elongated planar electrode 205, a front multi-folding mirror 207, a rear multi-folding mirror 209, and an output coupling mirror 211. The elongated planar electrodes 203 and 205 are arranged such that they are substantially parallel to each other with a narrow inter-electrode gap 206 therebetween. In accordance with one or more embodiments, the inter-electrode gap 206 is at least partially filled with a laser gain medium that serves as a discharge region. In accordance with one or more embodiments, the discharge region is defined to be the space between the inner surfaces 203a and 205a of the elongated planar electrodes 203 and 205, respectively. As described in further detail below, the inner surfaces 203a and 205a serve as two elongated resonator walls that bound the discharge region, and, in some embodiments, may also serve as waveguiding surfaces for the intra-cavity laser beam in the transverse direction (y-direction). While the example shown in FIG. 2A is a slab laser that employs planar electrodes 203 and 205, any electrode shape is possible without departing from the scope of the present disclosure. For example, U.S. Pat. No. 6,603,794, incorporated by reference herein in its entirety, discloses a number of different electrode arrangements, e.g., contoured electrodes, tapered electrodes, and/or annular electrodes may be used.

The slab laser 201 shown in FIG. 2A further includes an optical resonator that is formed between the output coupling mirror 211 and front multi-folding mirror 207. Further details of the optical resonator, including, e.g., the beam path of the intra-cavity laser beam through the optical resonator, are shown in FIG. 3A and discussed in more detail below. In accordance with one or more embodiments, a pair of spherical optical elements may be used for the front and rear multi-folding mirrors 207 and 209, respectively, and a planar mirror may be used for the output coupling mirror 211. As an example, the radius of curvature of the rear spherical optic may be between 30 cm and 5 meters, while the radius of curvature of the front optic may be 30 cm and infinity (i.e. be planar). However, other embodiments may use radii of curvature outside this range without departing from the scope of the present disclosure. Moreover, other embodiments may use spherical optics, cylindrical optics, toroidal optics, or generally aspherical optics, or any combinations thereof for the resonator without departing from the scope of the present disclosure. In addition, in accordance with one or more embodiments, the optics may be mounted to end flanges (not shown) that maintain vacuum integrity while at the same time providing suitable adjustment of the mirror tilt to enable optimum alignment of the constituent mirrors of the optical resonator.

In the slab laser example shown in FIG. 2A, the elongated planar electrodes 203 and 205 are part of an electrical resonator such that the inter-electrode gap bounded by the resonator surfaces 203a and 205a serves as a discharge region for the gas lasing medium. For example, such electrodes may have lengths of up to 1 meter, widths of up to 0.5 meters, and inter-electrode gaps on the order of 1-5 mm However, other embodiments may use dimensions outside this range without departing from the scope of the present disclosure. In accordance with one or more embodiments, when radio frequency (commonly referred to as “RF”) power is applied to the gas lasing medium via elongated planar electrodes 203 and 205, a gas discharge forms within the inter-electrode gap 206. As described in more detail below, laser energy builds up within one or more modes, including a fundamental mode, of the optical resonator, eventually forming an intra-cavity laser beam (not shown) that travels back and forth between the output coupling mirror 211 and front multi-folding mirror 207 via rear multi-folding mirror 209. Some fraction of the intra-cavity laser beam is transmitted through the output coupling mirror 211 and forms output laser beam 215. Furthermore, as described in more detail below, one or more undesirable higher order lasing modes and/or parasitic lasing modes that might have developed between one or more minors within the optical resonator may be suppressed through the use of strategically placed parasitic mode suppressors. If allowed to persist, the parasitic and/or higher order modes may not only decrease the efficiency of the laser but may also decrease the output power and may also negatively affect the quality of the output laser spatial mode.

In the illustrative embodiment shown in FIG. 2A, the electrical resonator cavity, and consequently the gas discharge area, may be rectangularly shaped. However, alternative embodiments may employ a square, annular, or other electrical resonator cavities. The resonator surfaces 203a and 205a may be bare electrode surfaces or may also be plated electrode surfaces. Suitable materials for bare embodiments include metals such as aluminum and other metallic alloys. Plated embodiments may employ a ceramic material, such as alumina or beryllia, on the electrode surfaces.

FIG. 2B, shows one example of an electrical resonator in accordance with one or more embodiments. The electrical resonator may be formed from a ceramic body 223 that is sandwiched between the pair of elongated planar electrodes 203 and 205. The ceramic body 223 includes an open-ended inner cavity 219 within which is located the laser gain medium. In this example, the open-ended inner cavity 219 includes elongated sidewalls 204a and 204b that join elongated top wall 206 with elongated bottom wall 208. Similar to the process described above in reference to FIG. 2A, radio frequency power may be applied to a gas lasing medium located within the open-ended inner cavity 219 via the elongated planar electrodes 203 and 205. Consequently, for examples where the laser gain medium is a gas, a gas discharge forms within the semi-closed inner cavity 219. Thus, in this embodiment, the ceramic inner cavity surfaces 219a and 219b form the two elongated resonator walls that bound the discharge region and, in some embodiments, may also serve as waveguiding surfaces for the intra-cavity laser beam in the transverse direction (y-direction).

As alluded to above, in accordance with one or more embodiments, the inter-electrode gap region (or inner cavity region) may be filled with a gas lasing medium. For example, the gas lasing medium may be a mixture of one part carbon dioxide (CO₂), one part nitrogen (N₂), and three parts helium (He), with the addition of 5% xenon (Xe). The gas pressure may be maintained in a range of approximately 30-150 Torr, e.g., 90 Torr. However, other embodiments may use higher pressures without departing from the scope of the present disclosure. Other embodiments of the invention may use other types of gas lasers, examples of which are listed in Table 1.

TABLE 1

| Type of Laser | Gas Lasing Medium |
|---|---|
| Carbon Dioxide | Some mixture of He, N₂, CO₂ and other gases such |
| | as Xe, O₂, and H₂. |
| Carbon Monoxide | Some mixture of He, N₂, CO, and other gases such |
| | as Xe, CO₂, O₂, and H₂. |
| Helium Cadmium | Some mixture of He, Cd, including other inert gases |
| HeNe Lasers | Some mixture of He, Ne, including other inert gases |
| Krypton Ion Lasers | Some mixture of Kr, He, including other inert gases |
| Argon Ion Lasers | Some mixture of Ar, He, including other inert gases |
| Xenon | Xe, including other inert gases |
| Argon Xenon Lasers | Some mixture of Ar, Xe, He |
| Copper Vapor Laser | He/Ne + copper vapor (metal at high temp) + traces |
| | of other gases including H₂ |
| Barium Vapor Laser | He/Ne + Barium vapor |
| Strontium Vapor | He/Ne + Strontium vapor |
| Laser | |
| Metal Vapor Laser | Almost any metal vapor will lase given the right |
| | mixture of gases, temperature, and excitation |
| | conditions |
| Metal Halide | Almost all the above metals will also lase in their |
| Vapor Lasers | respective halide compounds, at lower |
| | temperatures, under slightly different excitation |
| | conditions |
| Excimer lasers | XeCl, XeF, ArF |
| Chemical lasers | HF, DF |
| Atmospheric lasers | Atmospheric gas |
| Nitrogen lasers | N₂, plus others |
| Sulphur, Silicon | Vapors of these elements |
| Iodine, Bromine, | Vapors of these elements |
| Chlorine | |
| COIL | Chemical Oxygen Iodine Laser |

Other gas mixtures may be used as well. For instance, some embodiments may use the following gas mixtures, or their isotopes, including portions of neon (Ne), carbon monoxide (CO), hydrogen (H₂), water (H₂O), krypton (Kr), argon (Ar), fluorine (F), deuterium, or oxygen (O₂) and other gases, examples of which are listed in Table 1 above, at various other gas pressures, e.g., 30-120 Torr, e.g., 50 Torr; however, it will be appreciated that other gaseous lasing media may also be employed. For instance, one example of a lasing medium includes one or more of the following vapors: copper, gold, strontium, barium, a halide compound of copper, a halide compound of gold, a halide compound of strontium, a halide compound of barium, and other vapors, examples of which are identified but not limited to those shown in Table 1 above.

Returning to FIG. 2A, in accordance with one or more embodiments, the slab laser 201 includes a power supply 217 that supplies excitation energy to the gas lasing medium located within gap 206 via the first and second elongated planar electrodes 203 and 205, respectively. Accordingly, the addition of excitation energy causes the gas lasing medium to emit electromagnetic radiation in the form of laser beam 215 that ultimately exits the optical resonator by way of output coupling minor 211. Included with the power supply 217 is a radio frequency generator 217a that applies the excitation energy to the first and second elongated planar electrodes 203 and 205. In accordance with one or more embodiments, the radio frequency generator may operate at a frequency of 81 MHz with an output power level of at least 300 W. Other embodiments may use other excitation frequencies and power levels without departing from the scope of the present disclosure. Furthermore, in accordance with one or more embodiments, the radio frequency generator may be connected to the electrodes in a bi-phase fashion such that the phase of the voltage on one of the first and second elongated planar electrodes 203 and 205 is shifted substantially 180 degrees relative to the voltage on the other of the first and second elongated planar electrodes 203 and 205. The bi-phase excitation may be accomplished by any technique known in the art, e.g., by the placement of inductors between the first and second electrodes. In accordance with one or more alternative embodiments, the radio frequency generator may be connected to one of the first and second elongated planar electrodes, such that only one of the first and second elongated planar electrodes is excited.

The excitation energy supplied by the power supply 217 in the embodiment shown in FIG. 2A may be radio frequency energy, but may also be associated with microwave, pulsed, continuous wave, direct current, or any other energy source that may suitably stimulate a lasing medium into producing laser energy. Furthermore, additional embodiments may utilize other forms of excitation including an optically pumped solid-state laser gain medium similar to that shown in FIG. 2C. In this example, the solid state material 225 may be excited by way of one or more flashlamps (not shown) or laser diodes (not shown).

In accordance with one or more embodiments, the inner surfaces 203a and 205a of the first and second elongated planar electrodes 203 and 205, respectively, are positioned sufficiently close to each other so that the inter-electrode gap acts as a waveguide along the y-axis for the laser radiation. Accordingly, when acting as waveguide surfaces, the inner surfaces 203a and 205a also act as optical resonator surfaces in the transverse direction (y-direction). In accordance with one or more embodiments, waveguiding occurs when πN<1, where N=D²/(4λL) is the Fresnel number of the guide and D is the width of the gap between the electrodes, L is the length of the optical cavity, and λ is the wavelength of the laser radiation. For a wavelength of about 10.6 microns, which is a common wavelength produced by a CO₂ laser, the waveguiding criterion is satisfied if the inter-electrode gap is less than 2 mm for a guide length of 40 cm. However, in other embodiments, the inter-electrode gap is large enough to allow for free space propagation, e.g., Gaussian beam propagation, of the laser beam in the y-direction. Accordingly, in this free space configuration, these surfaces serve to define the thickness of the gas discharge region without acting as a waveguide for the laser radiation. Other embodiments may use an inter-electrode gap that is between the waveguiding criterion and complete free space propagation.

FIG. 3A shows a stable multi-pass slab resonator 301 that may be used as the optical resonator discussed above in reference to FIG. 2A in accordance with one or more embodiments of the invention. In the multi-pass slab resonator 301, an intra-cavity laser beam 303 passes multiple times through a lasing medium 305, thereby forming the multi-pass optical resonator 301. In accordance with one or more embodiments, the multi-pass optical resonator 301 may use an output-coupling mirror 307, a front multi-folding mirror 309, and a rear multi-folding mirror 311. The front multi-folding mirror 309 and a rear multi-folding mirror 311 may be aligned to induce a certain number of passes of the intra-cavity laser beam 303 through the lasing medium 305, e.g., five passes in the example shown in FIG. 3A. As shown in FIG. 3A, the lasing medium 305 may be divided into two or more regions including one or more gain producing regions 304 and one or more superfluous regions, e.g., triangularly shaped superfluous regions 313. As used herein, the areas or regions of lasing medium 305 that are traversed by the intra-cavity laser beam 303 are defined to be the gain producing regions 304 and the areas or regions not traversed by the intra-cavity laser beam 303 are defined to be the superfluous regions 313. For example, FIG. 3A shows superfluous regions 313 that are not traversed by the intra-cavity beam 303 and thus are superfluous regions in the sense that they are not necessary for lasing to occur.

Furthermore, as shown in FIG. 3B, depending on their relative alignment, front multi-folding mirror 309 and rear multi-folding mirror 311 may support the formation of a parasitic laser oscillation 315 that may oscillate in the fundamental mode of the stable resonator that is formed between multi-folding mirror 309 and rear multi-folding mirror 311. For example, as shown in FIG. 3B, a parasitic laser oscillation 315 may form and pass through the lasing medium 305 if the tilt between the multi-folding mirrors 309 and 311 is small. For certain alignments, the parasitic laser oscillation 315 may be made to overlap with one or more of the superfluous regions 313 not traversed by the intra-cavity beam 303. Thus, in accordance with one or more embodiments, structures placed within the superfluous regions 313 may be used to suppress the parasitic oscillation 315 and increase the efficiency of the lasing medium 305 by minimizing or eliminating the parasitic use of the gain medium 305 by the parasitic laser oscillation 315. Furthermore, structures placed within the superfluous regions 313 may also be used to inhibit higher-order modes of the optical resonator. Inhibition of laser oscillation in the higher order modes leads to a beneficial concentration of more laser power in the fundamental mode of the optical resonator and it is this laser oscillation in the fundamental mode of the optical resonator that yields the desired intra-cavity beam 303. In accordance with one or more embodiments, the superfluous regions 313 may further be used to increase the efficiency of the lasing medium 305 by minimizing or eliminating unnecessary excitation areas. Additionally, the superfluous regions 313 may be used to tune the electrical properties within the lasing medium 305, e.g., to tune the capacitance of the inter-electrode gap described above in reference to FIGS. 2A-2B.

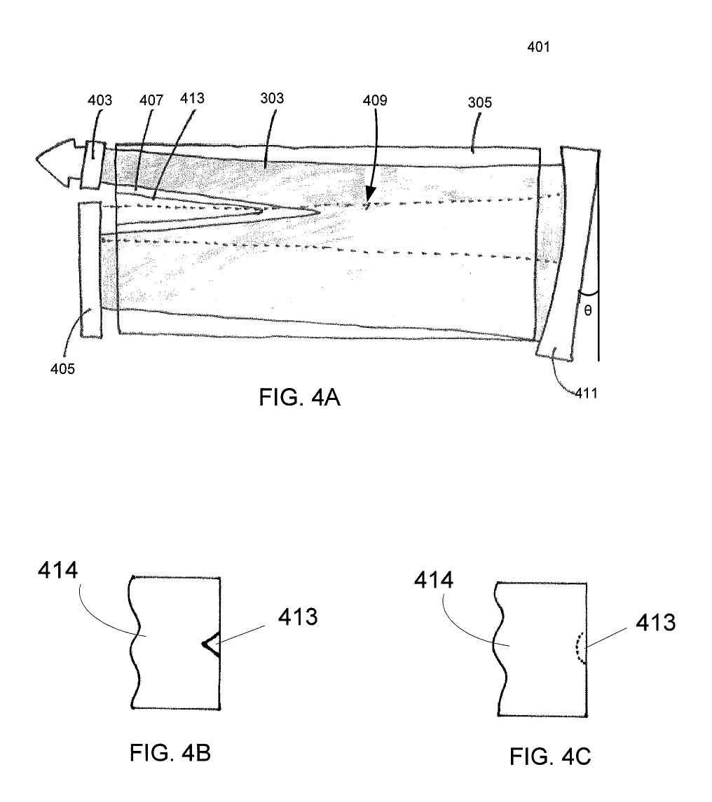

In accordance with one or more embodiments, FIG. 4 shows a multi-pass resonator 401 with parasitic mode suppression in accordance with one or more embodiments. As described above in reference to FIGS. 2 and 3, an optical resonator is formed between the output coupling mirror 403 and the front multi-folding mirror 405. As described above in reference to FIG. 3A, a superfluous region 407 may be made to overlap with at least a portion of a parasitic laser mode 409. In the example shown in FIG. 4, the partial spatial overlap of the parasitic laser mode 409 with the superfluous region 407 is accomplished by tilting the rear multi-folding mirror 411 by the angle 0. In the multi-pass resonator 401 shown in FIG. 4, the formation of parasitic mode 409 is suppressed by the presence of a parasitic mode suppressor 413 within at least a portion of the superfluous region 407. For example, the parasitic mode suppressor 413 may be substantially the same shape as the a superfluous region 407, e.g., the parasitic mode suppressor 413 may have a substantially triangular shape. The parasitic mode suppressor may be made out of a metal material, such as aluminum, or a ceramic material, such as alumina, or any combination thereof Furthermore, metallic parasitic mode suppressors may be anodized or non-anodized. In accordance with one or more embodiments, a parasitic mode suppressor made out of reflective material may be shaped so as to reflect light away from a parasitic oscillation. Generally, the material(s) used for the parasitic mode suppressor may absorb, scatter, or deflect light that would otherwise contribute to a parasitic mode, without interfering with proper laser operation.

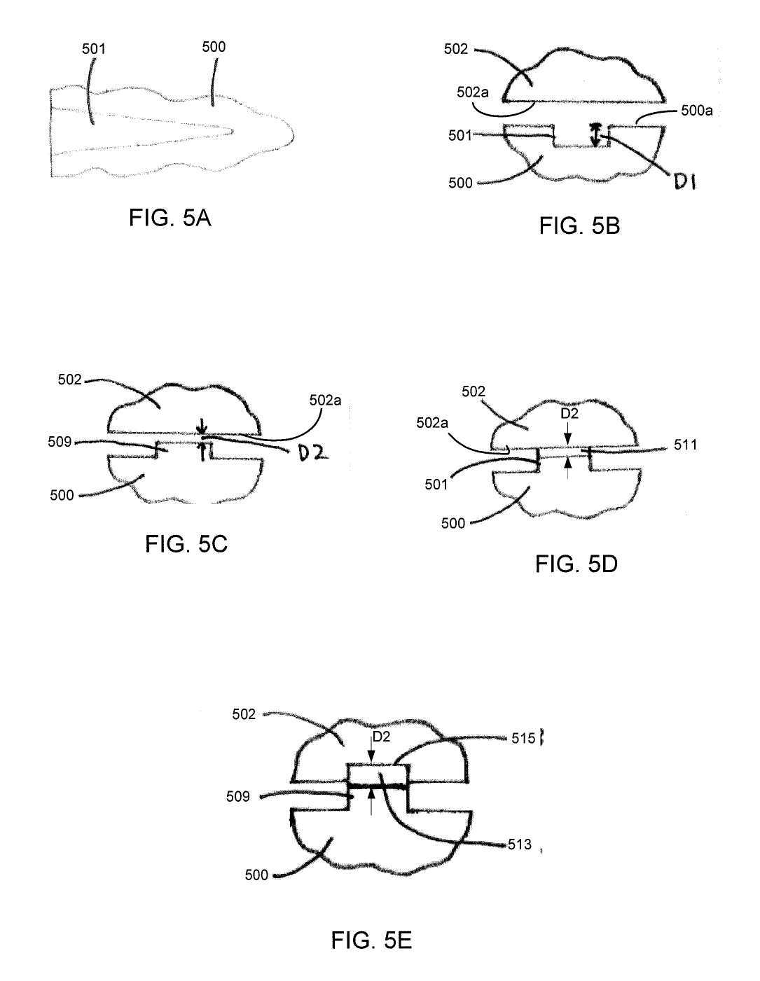

In all the examples that follow in FIGS. 5-8, a parasitic mode suppressor may be formed by a recess in, and/or a protrusion on, a resonator wall. For example, the wall on which a parasitic mode suppressor is located may be one or more inner surfaces of the first and second elongated planar electrodes that bound the inter-electrode gap, like that shown in FIG. 2A. In other examples, the resonator wall on which a parasitic mode suppressor is located may be one or more inner surfaces that bound an open-ended inner cavity of a ceramic body, like that shown in FIG. 2B. In other embodiments using a solid-state gain medium, like that shown in FIG. 2C, the parasitic mode suppressor may be embedded in the solid-state medium, with or without a surface of the parasitic mode suppressor being coplanar with one or more resonator wall surfaces. For example, the parasitic mode suppressor 413 may be embedded in the solid-state material or disposed on the outside end surface, as shown in the top views of FIGS. 4B and 4C. In the top view shown in FIG. 4B, the parasitic mode suppressor 413 is a triangular-shaped structure that is embedded into the end of the solid state gain medium 414. As described above, in reference to the other embodiments, this embedded structure may be a recess foamed in the gain medium itself. In FIG. 4C, the parasitic mode suppressor 413 is formed from a non-transmitting region in the gain medium itself, such a region may be formed, e.g., by bleaching that portion of the gain medium 414.

FIG. 5A shows a top view of resonator 500 having a parasitic mode suppressor 501 fanned as a triangular-shaped recess in the wall of resonator 500. While the recess shown in FIG. 5A is triangular in shape, any shape may be used without departing from the scope of the present disclosure. FIG. 5B shows a cross-sectional view of the same recess-type parasitic mode suppressor 501. In the example shown in FIG. 5B, the recess-type parasitic mode suppressor 501 is formed on resonator wall 500a. In other embodiments, a recess may alternatively be formed in the opposing resonator wall, e.g., in resonator wall 502a.

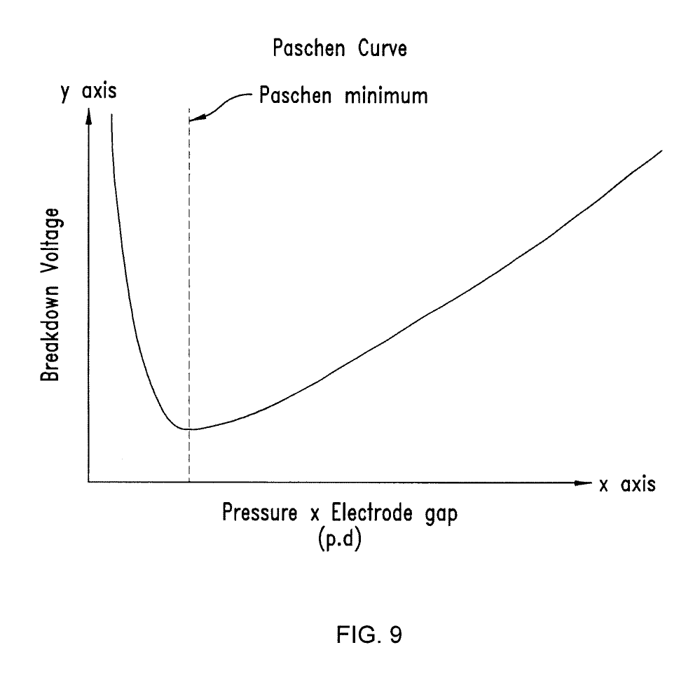

In embodiments that employ a gaseous gain medium, e.g., in gas discharge laser embodiments, the depth D1 of the recess-type parasitic mode suppressor 501 may be chosen to substantially reduce, or even eliminate, the gas discharge in the area of the recess. In other words, the presence of the recess-type parasitic mode suppressor 501 acts to substantially reduce, or even eliminate gas discharge in the superfluous region, e.g., superfluous region 407 shown in FIG. 4. The minimum depth D1 needed to suppress the gas discharge depends on the technical details of how the electrical excitation of the lasing medium is provided and also depends on the type and composition of the gaseous mixture that is used as the lasing medium within the discharge region. For example, the breakdown voltage may be described as depending on the product of gap size and gas pressure and generally follows what is known as the Paschen Curve, an example of which is shown in FIG. 9. Accordingly, for a given gas pressure, the minimum depth D1 should be chosen such that the breakdown voltage of the inter-electrode gap plus D1 always exceeds the excitation voltage available in the resonator structure. For example, the depth D1 may be chosen to be at least equal to the inter-electrode gap, thereby making an effective gap that is at least twice the inter-electrode gap, although any appropriate depth may be chosen without departing from the scope of the present disclosure. For example, for an inter-electrode gap of 2 mm, a minimum depth of 2 mm may be chosen, for a full gap of 4 mm.

The substantial reduction and/or elimination of gas discharge in the superfluous region leads to a corresponding substantial reduction and/or elimination of the gain in the superfluous region. Consequently, without an effective gain medium in the superfluous region, the parasitic oscillation, e.g., parasitic oscillation 309 shown in FIG. 3 (or parasitic oscillation 409 in FIG. 4), may be prevented from establishing itself inside the resonator.

In accordance with one or more embodiments, the recess-type parasitic mode suppressor 501 may also be sized so as to eliminate the gain available to higher-order modes of the desired oscillation. For gas discharge lasers in which modes perpendicular to the resonator walls are waveguide in nature, the presence of recess-type parasitic mode suppressor 401 disperses any oscillation passing above the area of recess-type parasitic mode suppressor 401, thereby additionally increasing the losses for a parasitic oscillation and any higher-order modes. For example, in the case of Gaussian beam propagation in rectangular symmetry, the beam radius of a higher-order mode is greater than that of the fundamental mode by a factor of sqrt(2m+1), where m=1 is the first higher-order mode, m=2 is the second high-order mode, etc. Therefore, in order to inhibit certain higher-order modes, the size of the parasitic mode suppressor should be chosen such that it is large enough to obstruct the beam radius of the higher-order modes (m>1) but not the fundamental mode (m=0).

In accordance with one or more embodiments, the parasitic mode suppressor may be a protrusion on the resonator wall as shown in the cross-sectional view of FIG. 5C. Such a protrusion-type parasitic mode suppressor 509 may be formed as part of the inner surface 500a of the resonator wall 500. In an embodiment where the protrusion-type parasitic mode suppressor 509 is formed directly as part of the surface of an electrode, e.g., elongated electrode 203 and 203 shown in FIG. 2A, a distance D2 may separate the protrusion-type parasitic mode suppressor 509 from the opposing surface 502a of resonator wall 502 in order to prevent an electrical short from occurring between the electrodes. In addition, as shown in FIG. 5D, a layer 511 of an electrically insulating material may be disposed between the protrusion-type parasitic mode suppressor 509 and the opposing surface 502a. In other embodiments, as shown in FIG. 5E, a layer 513 of an electrically insulating material may be partially inserted into a recess 515 in the opposing wall.

In gas discharge lasers, a protrusion-type parasitic mode suppressor 509 as shown in FIGS. 5C-5E may also serve to suppress unwanted gas discharge if the separation distance D2 is smaller than a certain value. The maximum separation distance D2 needed to suppress a discharge depends on the excitation of the lasing medium. Referring to the Paschen Curve shown in FIG. 9, the maximum separation distance D2 can be understood as the value occurring to the left of the Paschen minimum above which the breakdown voltage exceeds the excitation voltage available in the resonator structure. The maximum separation distance D2 can be further understood as the distance beyond which the combined thickness of the ion sheaths surrounding the gas plasma discharge is no longer less than the separation distance D2. In accordance with one or more embodiments, the thickness of the ion sheaths depends on the excitation frequency of the lasing medium. For an excitation frequency of 81 MHz, a maximum separation distance of 0.3 mm is typical.

In view of the above, the protrusion-type parasitic mode suppressor 509 may improve laser efficiency, as described above in reference to FIGS. 5A-5B. Furthermore, improved beam quality may be achieved by suppressing higher-order modes in the transverse direction parallel to the resonator walls, also as described above in reference to FIGS. 5A-5C. Additionally, in gas discharge lasers, protrusion-type parasitic mode suppressor 509 may be used to facilitate the establishment of the lasing medium by introducing regions of high field for improved breakdown while still reducing the gain in the superfluous regions. For example, regions of high electric field may occur around any sharp points or edges of a parasitic mode suppressor, e.g., near a 90-degree edge or corner. These regions of high electric field may create a region of field that is much more intense than that created by the substantially planar resonator walls thereby improving breakdown in the area or region surrounding the high field regions. The resulting improved breakdown may then have the effect of improving power extraction and/or laser pulsing performance, among other things.

In addition, for systems in which the power supply circuitry would not be destroyed by a contact between the two resonator walls, a protrusion-type parasitic mode suppressor may fully span the spacing between the first and second resonator walls. Furthermore, a protrusion-type and/or recess-type parasitic mode suppressor may be shaped so as to achieve a desired capacitance between the first and second elongated planar electrodes 203 and 205. For example, the capacitance of the parasitic mode suppressor may be tuned by varying the cross sectional area A or the gap d, in which case, the capacitance is given by C=εᵣε₀A/d, where εᵣ is the relative permittivity of the gap, ε₀ is the permittivity of free space, and A is the area of the protrusion surface at a distance d away from the opposing resonator wall. To this end, the electrically insulating material 511 or 513, e.g., as shown in FIGS. 5D-5E, respectively, may be a dielectric material used to tune the dielectric permittivity of the gap between the elongated planar electrodes within the superfluous region.

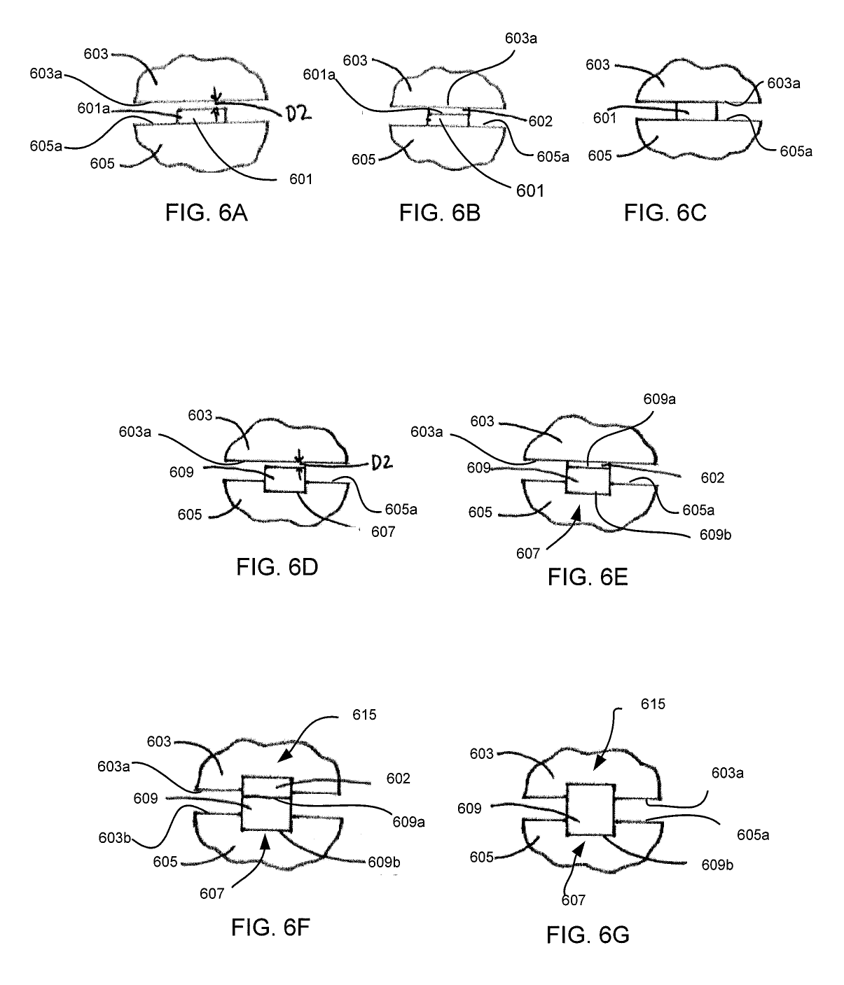

In accordance with one or more embodiments, a parasitic mode suppressor 601 may be an insert 609 that is formed separately from, and then disposed between, the surfaces 603a, 605a, of the resonator walls 603, 605, respectively, as shown in FIG. 6A-6G. Formed as a separate entity from the resonator walls 603 and 605, an insert-type parasitic mode suppressor 601 may advantageously be made out of any appropriate material. For a choice of the insert material requiring electrical isolation, e.g., if a metal is used to form the insert, a distance D2 may separate the insert-type parasitic mode suppressor 601 from the opposing resonator, e.g., wall 603a in FIG. 6A. In addition, in a manner similar to that described above in reference to FIGS. 5A-5E, a separation distance D2 between the wall 601a of the insert-type parasitic mode suppressor 601 and the opposing resonator wall surface 603a may be chosen to suppress a gas discharge, thereby suppressing parasitic and higher-order resonator modes. Furthermore, the gap D2 may be used to tune the capacitance between electrodes if desired. Furthermore, the shape of the parasitic mode suppressor may be used to introduce higher field regions, if desired. Furthermore, as shown in FIG. 6B, an electrically insulating material 602 may be disposed between the upper surface 601a of the insert-type parasitic mode suppressor and the opposing resonator wall 603a as shown in FIG. 6B. Likewise, the insulating material 602 may be disposed between the lower surface 601b of the insert-type parasitic mode suppressor and the opposing resonator wall 605a without departing from the scope of the present disclosure. In addition, if electrical isolation between the walls is not necessary, or even if electrical isolation between the walls is necessary, but the insert itself is made entirely from an insulating material, the insert-type parasitic mode suppressor 601 may span the entire gap between the walls 603a and 605a of the resonator 603 and 605, respectively, as shown in FIG. 6C.

FIG. 6D-6G show other embodiments of insert-type parasitic mode suppressors.

In these embodiments, the parasitic mode suppressor may be an insert 609 that is formed separately and inserted into one or more recesses 607 in one or more resonator walls. As already described above in reference to FIGS. 6A-6E, if the insert material requires electrical isolation, e.g., if a metal is used to form the insert, a distance D2 may separate the insert-type parasitic mode suppressor 609 from the opposing resonator wall, e.g., wall 603a in FIG. 6D. Furthermore, as shown in FIG. 6E, an electrically insulating material 602 may be disposed between an upper surface 609a of the insert-type parasitic mode suppressor and the surface 603a of the opposing resonator wall 603.

Likewise, the electrically insulating material 602 may be disposed between a lower surface 609b of the insert-type parasitic mode suppressor and the surface 603b of the opposing resonator wall 603. Similarly, as shown in FIG. 6F, an electrically insulating material 602 may be disposed between an upper (or lower) surface 601a of the insert-type parasitic mode suppressor and within a recess in a resonator wall, e.g., recess 615 on resonator wall surface 603a. In addition, if electrical isolation between the walls is not necessary, or even if electrical isolation between the walls is necessary, but the insert itself is made entirely from an insulating material, the insert-type parasitic mode suppressor 609 may span the entire gap between the walls 603a and 605a of the resonators 603 and 605, respectively, and may also fit within recesses 607 and 615 formed within the resonator walls 603a and 605a, respectively, as shown in FIG. 6G.

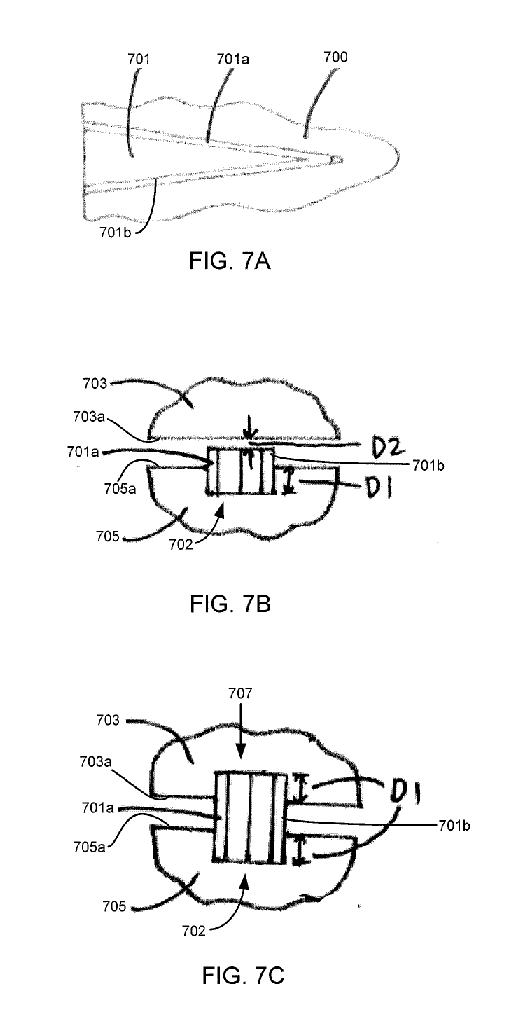

FIG. 7A shows a top view of a hollow parasitic mode suppressor 701 formed from walls 701a and 701b that are disposed within a recess that is located in resonator 700. FIG. 7B shows a cross-sectional view of the same hollow parasitic mode suppressor 701. Similar to the embodiments described above, in gas discharge lasers, the depth D1 of the recess 702 may be chosen so as to substantially reduce or eliminate a gas discharge within the superfluous region. Furthermore, similar to that described above in reference to FIGS. 6A-6E, if the resonator walls 703a and 705a require electrical isolation from each other, e.g., if a metal is used to form the insert walls 701a and 701b, a distance D2 may separate the insert-type parasitic mode suppressor 701 from the opposing resonator wall, e.g., wall 703a in FIG. 7B. In addition, if electrical isolation between walls 703a and 705a is not necessary, or even if electrical isolation between the walls is necessary, but the insert itself is made entirely from an insulating material, the insert-type parasitic mode suppressor 701 may span the entire gap between the walls 703a and 705a and/or may also fit within recesses 702 and 707 formed within the resonator walls 705 and 709, respectively, as shown in FIG. 7C.

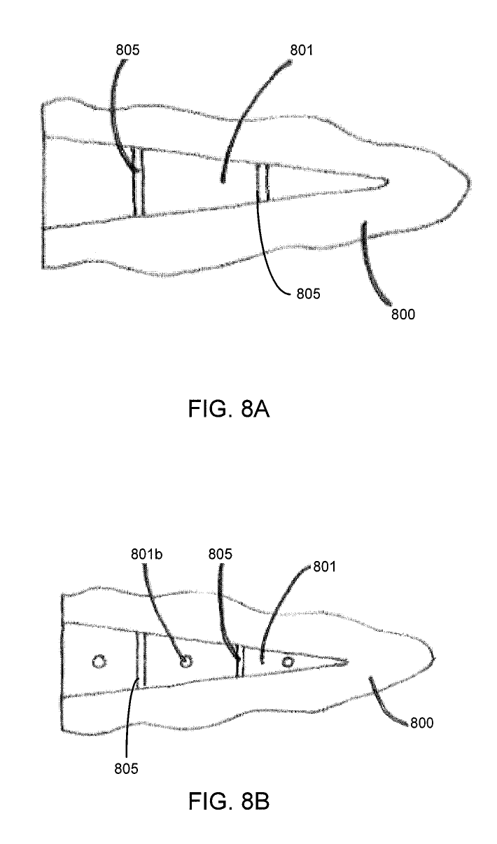

FIGS. 8A-8B are top views of parasitic mode suppressors of either the protrusion-type or insert-type. In FIG. 8A, the protrusion/insert type parasitic mode suppressor 801 may be either formed directly out of the resonator wall surface 800 or may be formed separately and adhered onto the resonator wall surface 800 using an appropriate adhesive. In addition, the protrusion/insert type parasitic mode suppressor 801 may be affixed to, or positioned by fasteners/pins 801b, as shown in FIG. 8B. Furthermore, in all the above examples, it may be the case that the presence of a relatively long protrusion/insert inside a gas discharge volume negatively affects the establishment of the lasing medium due to a restriction of the overall flow of gas through the discharge region. Accordingly, one or more cross-channels 805 may be included in the protrusion/insert-type parasitic mode suppressor 801 to allow gas flow between regions on either side of the mode suppressor. In accordance with one or more embodiments, the cross-channels channels may serve as vents and also allow for improved pulsing performance of the laser employing the resonator.

In all of the above examples, the specific shapes of the parasitic mode suppressors are shown merely for the sake of illustration and thus, these structures may have any shape (e.g., circular, rectangular, elliptical, triangular, etc.) without departing from the scope of the present disclosure. Furthermore, while the parasitic mode suppressor embodiments above are shown in the context of stable resonators used in gas discharge and/or solid state lasers, the parasitic mode suppressors disclosed herein may be used in any laser resonator, including unstable resonators, without departing from the scope of the present disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A resonator for a laser comprising:
a first resonator wall;
a second resonator wall that is separated from the first resonator wall in a transverse direction thereby defining a gap between the first and second resonator walls;
a lasing medium disposed in the gap;
a first mirror disposed at a first end of the first and second resonator walls;
a second mirror disposed at a second end of the first and second resonator walls,
wherein the mirrors cooperate to form an intra-cavity laser beam that travels along a plurality of paths through the lasing medium,
wherein the plurality of paths define a boundary of a superfluous region within the resonator, wherein the intra-cavity laser beam does not pass through the superfluous region;
wherein the first mirror and the second mirror fowl a laser resonator for a parasitic laser mode, a portion of which is located within the superfluous region; and
a parasitic mode suppressor that is located within the superfluous region.

2. The resonator of claim 1, wherein the parasitic mode suppressor is a recessed area on at least one of the first resonator and the second resonator wall.

3. The resonator of claim 1, wherein the parasitic mode suppressor is a protrusion on at least one of the first resonator and the second resonator wall.

4. The resonator of claim 1, wherein the parasitic mode suppressor is a spacer and the spacer is disposed in the gap.

5. The resonator of claim 1, wherein the parasitic mode suppressor is a spacer and the spacer is at least partially disposed in a recessed area formed within at least one of the first resonator wall and the second resonator wall.

6. The resonator of claim 1, wherein the parasitic mode suppressor is formed from one selected from a group consisting of a metal material and a ceramic material.

7. The resonator of claim 1, wherein the gap in a region adjacent to an upper surface of parasitic mode suppressor is less than or equal to about 0.3 mm.

8. The resonator as claimed in claim 1, wherein the lasing medium is a gas plasma discharge medium and the parasitic mode suppressor reduces a gas discharge in the superfluous region.

9. The resonator of claim 1, wherein the lasing medium is a solid state lasing medium and the parasitic mode suppressor is structure that is embedded in the solid state lasing medium.

10. The resonator as claimed in claim 1, wherein the lasing medium is a gas plasma discharge and the gas plasma discharge in a region between the first or second resonator wall and a surface of the parasitic mode suppressor is reduced relative to another region of the gain medium and the reduction is due to the presence of the parasitic mode suppressor.

11. The resonator as claimed in claim 1, wherein the lasing medium is a gas plasma discharge and the presence of said structure facilitates the establishment of said discharge by concentrating an electric field near a sharp edge of the parasitic mode suppressor.

12. The resonator as claimed in claim 1, the parasitic mode suppressor further comprising a gas flow channel formed therethrough.

13. The resonator as claimed in claim 1, wherein the first mirror is an output coupling mirror and the second mirror is a first multi-folding mirror.

14. The resonator as claim in claim 13, further comprising a second multi-folding mirror.

15. The resonator of claim 14, wherein at least one of the first and second multi-folding mirrors are curved mirrors.

16. The resonator of claim 4, wherein the spacer is a hollow spacer.
